(19) United States
(12) Patent Application Publication
(10) Pub. No.: US 2019/0017424 A1
(43) Pub. Date: Jan. 17, 2019

(54) DIRECT REAGENT VAPORIZATION SYSTEM

(71) Applicant: Sisu Energy & Environmental, LLC, Tulsa, OK (US)

(72) Inventors: John R. Shaw, Tulsa, OK (US); Thomas W. Boyer, Collinsville, OK (US); Scott A. Taylor, Broken Arrow, OK (US)

(73) Assignee: Sisu Energy & Environmental, LLC, Tulsa, OK (US)

(21) Appl. No.: 15/649,309

(22) Filed: Jul. 13, 2017

(51) Int. Cl. F01N 3/20; F01N 3/30; B05B 7/00; B05B 1/00

(52) U.S. Cl. CPC F01N 3/2066; F01N 3/30; F01N 2610/00; B05B 1/005; B05B 7/0081

(57) ABSTRACT

The present invention provides for a protective sleeve for use with a reagent injection lance. The protective sleeve includes a tube having a bore therethrough. Further, the tube has a lance receiving end configured to receive a reagent injection lance and an exhaust gas chamber end that extends into an exhaust gas chamber. The tube further includes a shielding air opening located proximate to the lance receiving end and configured to receive shielding air. The shielding air enters into the bore through the shielding air opening, surrounds the lance, protecting it from the heat of the exhaust gas flow. The shielding air exits the bore through the exhaust gas chamber end.

### BACKGROUND OF THE INVENTION

### Field of the Invention

The present invention is generally directed toward a reagent injection lance, and more specifically, toward a reagent injection lance utilized with a combustion exhaust gas flow.

### Background

Combustion exhaust gas, otherwise referred to as flue gas, is emitted as a result of the combustion of fuels such as natural gas, gasoline, petrol, diesel fuel, fuel oil, or coal. Typically contained within the combustion exhaust gas are particulates of nitrogen oxides (NOx), a pollutant. Nitrogen oxides are treated either by modifications to the combustion process to prevent their formation, or by high temperature or catalytic reaction with a reagent such as ammonia or urea. In either case, the aim is to produce nitrogen gas, rather than nitrogen oxides.

In the catalytic reaction, the prior art has a number of various apparatuses and processes. One apparatus is the use of an injection lance having an atomizing nozzle. The atomizing nozzle is placed within the exhaust gas flow while an aqueous ammonia (ammonia mixed with water) flow passes through the lance. The atomizing nozzle creates an ammonia spray or mist that is absorbed into the exhaust gas flow. The use of the lance however has disadvantages. The heat from the exhaust gas stream may vaporize the aqueous ammonia solution within the lance resulting in poor atomization and improper NOx reduction and/or pre-mature catalyst wear. Further, the atomizing nozzle can more easily become clogged with particulates that require the process to be shut down in order to clear the nozzle.

Clearly, there is a need for an improved direct reagent vaporization system.

### BRIEF SUMMARY OF THE INVENTION

The present invention satisfies the needs discussed above. The present invention is generally directed toward a reagent injection lance, and more specifically, toward a reagent injection lance utilized with a combustion exhaust gas flow.

One aspect of the present invention is directed toward a protective sleeve for use with a reagent injection lance. The protective sleeve includes a tube having a bore therethrough. The tube has a lance receiving end and an exhaust gas chamber end. The protective sleeve penetrates through the wall of an exhaust gas chamber such that the exhaust gas chamber end extends into the exhaust gas flow. The lance receiving end is configured to receive a lance having an atomizing nozzle. The lance extends through the protective sleeve such that the atomizing nozzle is located within the exhaust gas chamber.

The protective sleeve further includes a shielding air opening located proximate to the lance receiving end and configured to receive shielding air. The shielding air enters into the bore through the shielding air opening and exits the bore through the exhaust gas chamber end. Shielding air enters the tube at a lower temperature and higher pressure than the exhaust gas flow. The shielding air is supplied by a shielding air source such an air blower. When a lance is located within the bore, the shielding air surrounds the lance which protects the lance from the heat of the exhaust gas flow.

Further, when aqueous ammonia, urea, or other reagent exits the lance, it is atomized into droplets. These droplets mix with the shielding air as they exit the tube. Due to lower temperature and the higher velocity of the shield air flow through the tube, the atomization and distribution of reagent is enhanced due to the further transportation of the droplets into the exhaust flow stream.

Further, due to shielding air having a higher pressure than the exhaust gas stream, the lance can be removed for maintenance or replacement without allowing the escape of the exhaust gas. This allows for the continued operation of the combustion equipment during such maintenance or replacement activities.

Another aspect of the present invention includes the protective sleeve as set out above further having a shield air shut-off valve that is in communication with the lance receiving end of the tube. This shut-off valve is designed to close the lance receiving end such that shield air is prevented from exiting the bore through the lance receiving end to prevent excessive loss of air during lance maintenance or replacement.

It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

Upon reading the above description, various alternative embodiments will become obvious to those skilled in the art. These embodiments are to be considered within the scope and spirit of the subject invention, which is only to be limited by the claims which follow and their equivalents.

### BRIEF DESCRIPTION OF THE DRAWINGS

FIG. 1 is a top view of an embodiment of the present invention.

FIG. 2 is a top perspective view of an embodiment of the present invention.

FIG. 3 is a schematic illustration an embodiment of the present invention.

### DESCRIPTION OF THE INVENTION

The present invention satisfies the needs discussed above. The present invention is generally directed toward a reagent injection lance, and more specifically, toward a reagent injection lance utilized with a combustion exhaust gas flow.

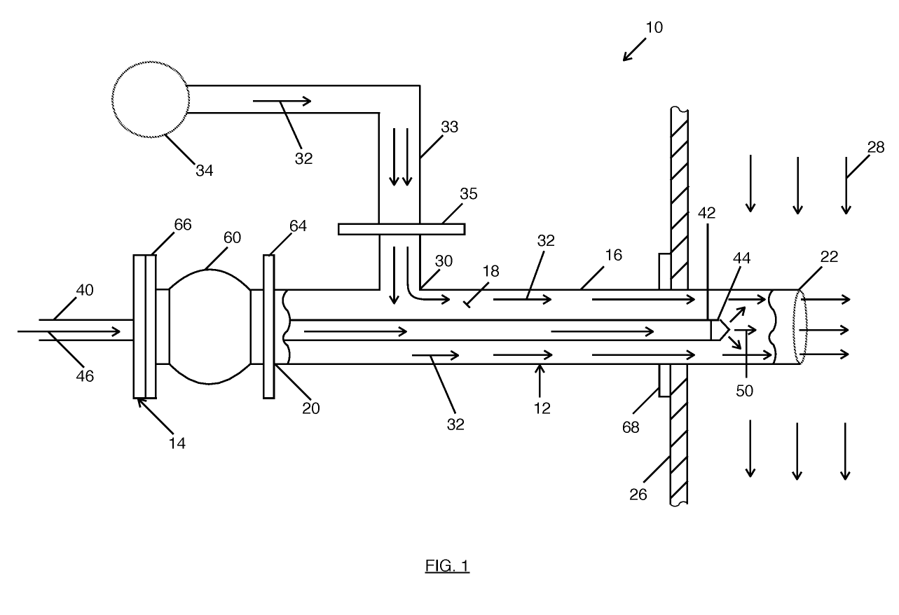

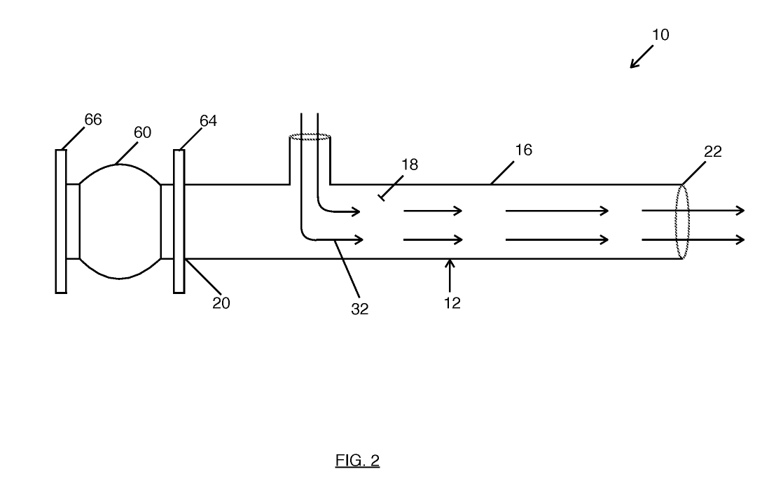

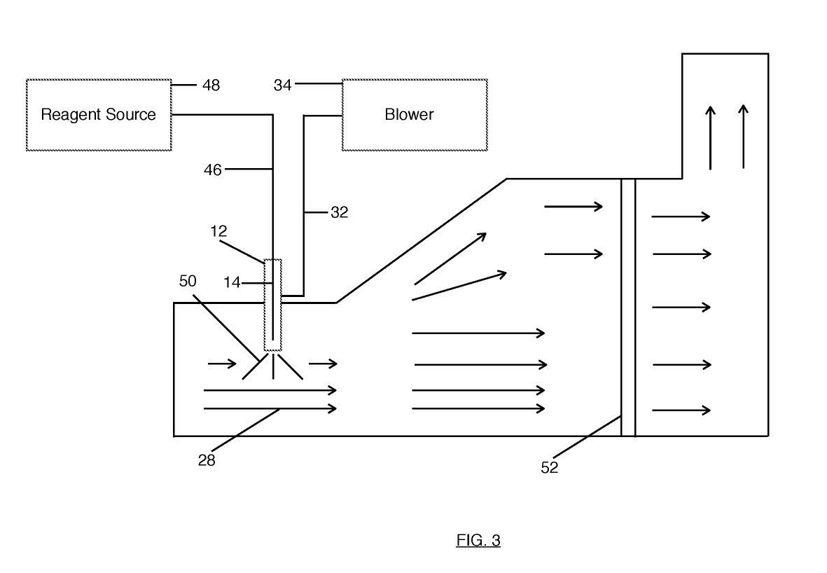

An embodiment 10 of the present invention is illustrated in FIGS. 1-3. Embodiment 10 discloses a protective sleeve 12 for use with a reagent injection lance 14. Protective sleeve 12 comprises a tube 16 having a bore 18 therethrough. Tube 16 has a lance receiving end 20 and an exhaust gas chamber end 22. Protective sleeve 12 is configured to penetrate through the wall 26 of an exhaust gas chamber 26 such that the exhaust gas chamber end 22 extends into the exhaust gas flow 28. Protective sleeve 12 is secured to gas chamber 26 wall via a chamber wall fitting 68. Lance receiving end 20 is configured to receive the shield air shut-off valve and the reagent injection lance 14 having an atomizing nozzle 44.

In this embodiment 10, reagent injection lance 14 can be removably inserted into tube 16 through lance receiving end 20. Reagent injection lance 14 is secured to tube 16 via a lance fitting 66. Reagent injection lance 14 has a reagent fluid access end 40 and an atomizing end 42. An atomizing nozzle 44 is connected to reagent injection lance 14 at the atomizing end 42. Atomizing nozzle 44 is located within bore 18 and does not extend beyond exhaust gas chamber end 22 of tube 16. Liquid reagent 46 is provided from a reagent source 48 to reagent injection lance 14. The liquid reagent flow 46 travels through reagent injection lance 14 and exits through atomization nozzle 44 where it is dispersed as a mist of reagent droplets 50. Droplets 50 mix with exhaust gas flow 28. Downstream, the flow engages a SCR catalyst 52 which causes the NOx to convert into nitrogen gas.

Protective sleeve further comprises a shielding air opening 30 located proximate to lance receiving end 20 and configured to receive shielding air 32. Shielding air 32 enters into bore 18 through shielding air opening 30 and exits bore 18 through exhaust gas chamber end 22 and mixes with exhaust gas flow 28. In this embodiment 10, shielding air 32 is provided by an air blower 34 through a shielding air tube 33. Shielding air tube 33 is secured to shielding air opening 30 via a shielding air tube fitting 35. The use of a blower 34 as the shielding air source is merely illustrative. Those skilled in the art will recognize that other sufficient apparatus can be used to provide shielding air. Shielding air 32 enters tube 16 at a lower temperature and higher pressure than exhaust gas flow 28. When a reagent injection lance 14 is located within bore 18, shielding air 32 surrounds the reagent injection lance 14 which protects the reagent injection lance 14 from the heat of exhaust gas flow 28.

As liquid reagent 46 exits atomizing nozzle 44 as a mist of reagent droplets 50, they mix with the shielding air 32 as they exit tube 16. Due to lower temperature and the higher velocity of the shield air flow 32, the atomization and distribution of reagent droplets 50 is enhanced due to the further transportation of the droplets 50 into the exhaust gas flow stream 28.

Further, due to shielding air 32 having a higher pressure than the exhaust gas stream 28, the reagent injection lance 14 can be removed for maintenance or replacement without allowing the escape of the exhaust gas 28. This allows for the continued operation of the combustion equipment during such maintenance or replacement activities.

In this embodiment 10, a shield air shut-off valve 60 is attached to lance receiving end 20 of tube 16. Shield air shut-off valve 60 is secured to sleeve 12 via a sleeve fitting 64. The shield air shut-off valve 60 is capable of closing lance receiving end 20 such that shielding air 32 is prevented from exiting tube 16 during maintenance or replacement of the reagent injection lance 14. In this embodiment, lance fitting 66 is secured to shield air shut off valve 60.

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

What is claimed:

1. A protective sleeve for use with a reagent injection lance, the protective sleeve comprising:
a tube having a bore therethrough,
the tube having a lance receiving end configured to receive a reagent injection lance,
a shielding air opening located proximate to the lance receiving end and configured to receive shielding air, and
an exhaust gas chamber end,
wherein shielding air enters into the bore through the shielding air opening and exits the bore through the exhaust gas chamber end.

2. The protective sleeve of claim 1 further comprising shield air shut-off valve in communication with the lance receiving end of the tube, the shield air shut-off valve being configured to close the lance receiving end such that shield air is prevented from exiting the bore through the lance receiving end.

3. The protective sleeve of claim 1 further comprising a shield air source in communication with the shield air opening.

4. The protective sleeve of claim 3 wherein the shield air source is an air blower.

5. A direct reagent vaporization system for injecting atomized reagent into a hot exhaust gas chamber, the system comprising:
a tube having a tube bore therethrough, the tube having a lance receiving end configured to receive a reagent injection lance, a shielding air opening, and an exhaust gas chamber end, the tube extending through the wall of the exhaust gas chamber and into the exhaust gas chamber such that the exhaust gas chamber end being located inside the exhaust gas chamber and the lance receiving end being located outside of the exhaust gas chamber, the shield air opening located proximate to the lance receiving end and outside of the exhaust gas chamber;
a shield air source in communication with the shield air opening and providing shield air into the tube;
a reagent injection lance configured to be removably inserted into the bore of the tube through the lance receiving end, the reagent injection lance having a liquid reagent access end located outside the exhaust gas chamber, an atomizing end located inside the exhaust gas chamber and a reagent injection lance bore therebetween;
an atomizing nozzle connected to the atomizing end of the reagent injection lance; and
a reagent source in communication with the liquid reagent end of the reagent injection lance and providing liquid reagent into the reagent injection lance,
wherein the shield air within the tube surrounds the reagent injection lance and exits the tube through the exhaust gas chamber end and into the exhaust gas chamber; and
wherein the atomizing nozzle atomizes the liquid reagent as the reagent exits the reagent injection lance and enters into the exhaust gas chamber.

6. The direct reagent vaporization system of claim 5 wherein the atomizing end of the reagent injection lance and the atomizing nozzle do not extend beyond the exhaust gas chamber end of the tube.

7. The direct reagent vaporization system of claim 6 further comprising shield air shut-off valve in communication with the lance receiving end of the tube, the shield air shut-off valve being configured to close the lance receiving end such that shield air is prevented from exiting the bore through the lance receiving end.

8. The direct reagent vaporization system of claim 6 wherein the shield air source is an air blower.

9. The direct reagent vaporization system of claim 6, wherein the exhaust gas chamber has an exhaust gas stream flowing therethrough and, wherein the shield air exiting the tube is injected into the exhaust gas chamber at a pressure greater than the exhaust gas stream.
